(19) United States
(12) Patent Application Publication
(10) Pub. No.: US 2013/0238730 A1
(43) Pub. Date: Sep. 12, 2013

(54) ONLINE BACKUP SYSTEM

(71) Applicants: Eli Nir, San Francisco, CA (US); Shanna Traci McClearn, San Francisco, CA (US)

(72) Inventors: Eli Nir, San Francisco, CA (US); Shanna Traci McClearn, San Francisco, CA (US)

(21) Appl. No.: 13/789,611

(22) Filed: Mar. 7, 2013

Related U.S. Application Data
(60) Provisional application No. 61/607,840, filed on Mar. 7, 2012.

(51) Int. Cl. H04L 12/58

(52) U.S. Cl. CPC H04L 51/08
USPC 709/206

(57) ABSTRACT

A system and a method are disclosed for synchronizing files from email account systems. In one embodiment, the method comprises accessing a file stored in a memory of a local device, including determining a local file path specifying the location of the file in the memory. The file is uploaded to an email server, where it is stored in association with a user's email account. The local file path, email account information, and an identifier of the file are sent for storage by a management server. The uploaded file is accessed by the email account information and the file identifier.

### CROSS REFERENCE TO RELATED APPLICATIONS

This application claims the benefit of U.S. Provisional Application No. 61/607,840, filed Mar. 7, 2012, which is incorporated by reference in its entirety.

### BACKGROUND

1. Field of Art

The disclosure generally relates to the field of cloud storage, and in particular to backing up files using email account systems.

2. Description of the Related Art

Users often interact with files saved to a long-term storage of a local device, such as a hard disk. However, saving files saved only on a local device can be inconvenient, as the files are only accessible on one device. Thus, for example, a user cannot edit a file on two different devices and conveniently synchronize edits between the devices. Conventional cloud-based storage solutions provide users with the ability to access files from a plurality of devices, but often provide users with limited storage space. Moreover, conventional cloud storage solutions often rely on users moving files from their local devices to servers operated by the providers of the cloud storage, compromising security of the files.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG.) 1 illustrates one embodiment of an online backup environment.

FIG. 2 illustrates one embodiment of components of an example machine able to read instructions from a machine-readable medium and execute them in a processor (or controller).

FIG. 3A is a flowchart illustrating one embodiment of a user's process for setting up an online backup account.

FIG. 3B is a flowchart illustrating one embodiment of the file backup process.

FIG. 4 is a block diagram illustrating one embodiment of a backup application for managing the file backup process.

FIG. 5A is a decision tree illustrating one embodiment of a process for selecting a mail server to which files are to be uploaded.

FIG. 5B is an interaction diagram illustrating one embodiment of a process for uploading files to an email server.

FIG. 6 is an interaction diagram illustrating one embodiment of a process for downloading files from an email server.

FIG. 7 is an interaction diagram illustrating one embodiment of a process for synchronizing files between a local device and an email server.

FIG. 8 is an interaction diagram illustrating one embodiment of a process for playing music files backed up to an email server.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed method, computer readable storage medium, and system provides storage and backup of files on one or more servers configured to host email accounts (“mail servers”). In one embodiment, the method comprises accessing a file stored in a memory of a local device, including determining a local file path specifying the location of the file in the memory. The file is uploaded to a mail server, where it is stored in association with a particular user's email account. The local file path, email account information, and an identifier of the file are sent for storage by a management server. The uploaded file is accessed by the email account information and the file identifier.

Turning now to FIG. 1, the figure illustrates a high-level overview of an online backup environment 100. In one embodiment, the online backup environment 100 includes interactions between one or more mail servers 110, a local device 120, and a management server 150. Other embodiments may include additional or different entities. Although a single local device 120 is illustrated in FIG. 1, it is to be understood that many devices 120 may interact with the mail servers 110 and management server 150.

In one embodiment, the mail servers 110 are conventional email servers, operated by providers that host a user's email account (“email providers”). Users create accounts (“user account”) with the email providers, enabling them to store content on a server 110, access stored content, and send content from one server to another. Each account may be uniquely specified by a domain associated with the provider of the email account and a username identifying a particular account. Thus, for a given email account, emails sent to an email address of the form “username@domain” are stored on a mail server 110 in association with the user's account. In creating an account, the user may create a password to restrict unwanted access to the account. Furthermore, each email account may be provided with a storage quota by the email provider, which specifies the storage size allocated to a user. For example, a user account may be allotted 10 gigabytes (GB) storage space, indicating that the user can store up to 10 GB of data on the mail server 110 associated with the user's account. Depending on the storage space occupied by emails stored in association with the user account, each user account may have an available storage space less than or equal to its storage quota.

Each user email account may be associated with two servers: an outgoing server and an incoming server. For example, the outgoing server may use the Simple Mail Transfer Protocol (SMTP) or secure SMTP, and the incoming server may use the Internet Message Access Protocol (IMAP), secure IMAP, the Hypertext Transfer Protocol (HTTP), the Post Office Protocol (POP3), or a proprietary protocol. For ease of discussion herein, unless otherwise indicated, “mail server” is used to describe the incoming mail server (e.g., IMAP) associated with a user's email account. The mail servers 110 may further support other email protocols, such as the Multipurpose Internet Mail Extension (MIME) standard, for enabling the servers 110 to store and send emails with files of various formats attached to the emails.

The management server 150 is configured to interface between the local device 120 and the mail servers 110 to enable users to store files on the mail servers 110 and access the stored files. In one embodiment, the management server 150 is configured to manage the storage of files on mail servers 110. The management server 150 maintains a file information database 155 storing information about each uploaded file so that the file can be retrieved, synchronized, and shared. In one embodiment, users create backup accounts on the management server 150 by providing, for example, user authentication information, such as a username and password. Users can access files stored on the mail servers 110 from a plurality of different devices by logging in to their backup accounts on each of the devices, as further described herein.

Furthermore, the management server 150 increases available storage space for files by enabling users to link multiple email accounts, thereby connecting multiple mail servers 110, under a single backup account for storing files. Effectively, by maintaining current information about each file and a user's email accounts linked to the user's backup account, the management server 150 groups multiple email accounts into a single logical entity for storing the user's files.

In one embodiment, the file information database 155 stores tables with information about files to be synchronized by the management server 150, files that have been synchronized by the management server 150, user information, group sharing information, email information, system configuration settings, and user configuration settings. For each user's backup account on the management server 150, the file information database 155 may store the domain name of the mail servers 110 associated with the account and the user's username on each mail server 110. The file information database 155 may also store additional information about each email account, such as the storage quota available to the user on the specific email account and the amount of available storage space left against that quota. For example, the management server 150 may periodically send a command to a mail server 110 requesting the amount of available storage space associated with a particular user account, and store the received value in the file information database 155. The file information database 155 stores pointers indicating the locations of files stored on the mail server 110 (e.g., the folders in the email accounts in which the files are stored) and metadata of each file.

The management server 150 may be configured to also provide access through a website for users to create an account, modify settings, or download client applications. In one embodiment, the website may additionally provide access to the full functionality available through the management server 150. That is, rather than downloading a separate client application to the device 120, the user may upload or download files through the website.

The local device 120 is a computing device operated by a user. For example, the local device 120 may be a desktop computer, laptop computer, tablet, smartphone, set-top box, Internet television, or any other device having computing and network access functionality. The device 120 may include a storage device for storing various types of content. In one embodiment, the local device 120 executes one or more applications allowing users to create, access, or interact with files, such as a word processing application, a spreadsheet application, music or video players, or music, video, or photo editing applications.

In one embodiment, the device 120 stores files 122 that a user may backup on mail servers 110 according to varying embodiments. It is noted that “files” may refer to different types of content files stored in different formats. For example, the files 122 can include different word processor, spreadsheet, image, video, or music content. The various document formats include, for example, Microsoft Word™ documents (DOC), Apple Pages™ documents (PAGES), Office Open XML Text documents (DOCX), Adobe™ Portable Document Format documents (PDF), Microsoft Excel™ documents (XLS), Microsoft Windows Bitmap™ image documents (BMP), Compuserve Graphics Interchange Format™ image documents (GIF), Joint Photographic Experts Group image documents (JPEG), text files (TXT), Microsoft Windows Media Audio™ audio files (WMA), MPEG Layer 3 files (MP3), MPEG Layer 4 files (MP4), Apple Audio Video Interleave™ audio files (AVI), including any variants and/or derivatives of the above formats.

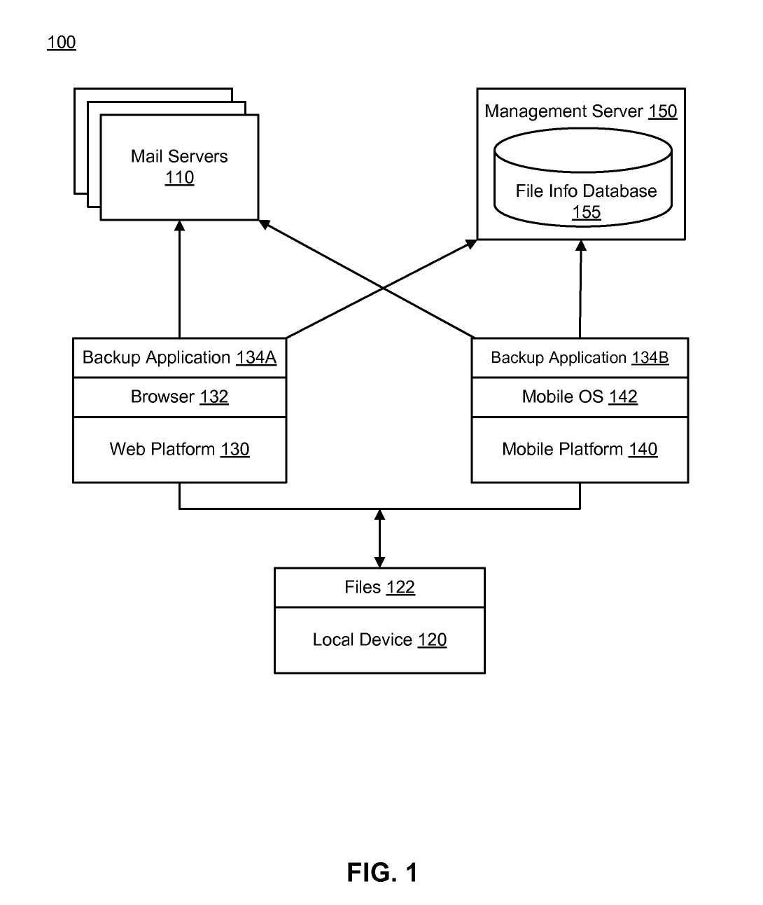

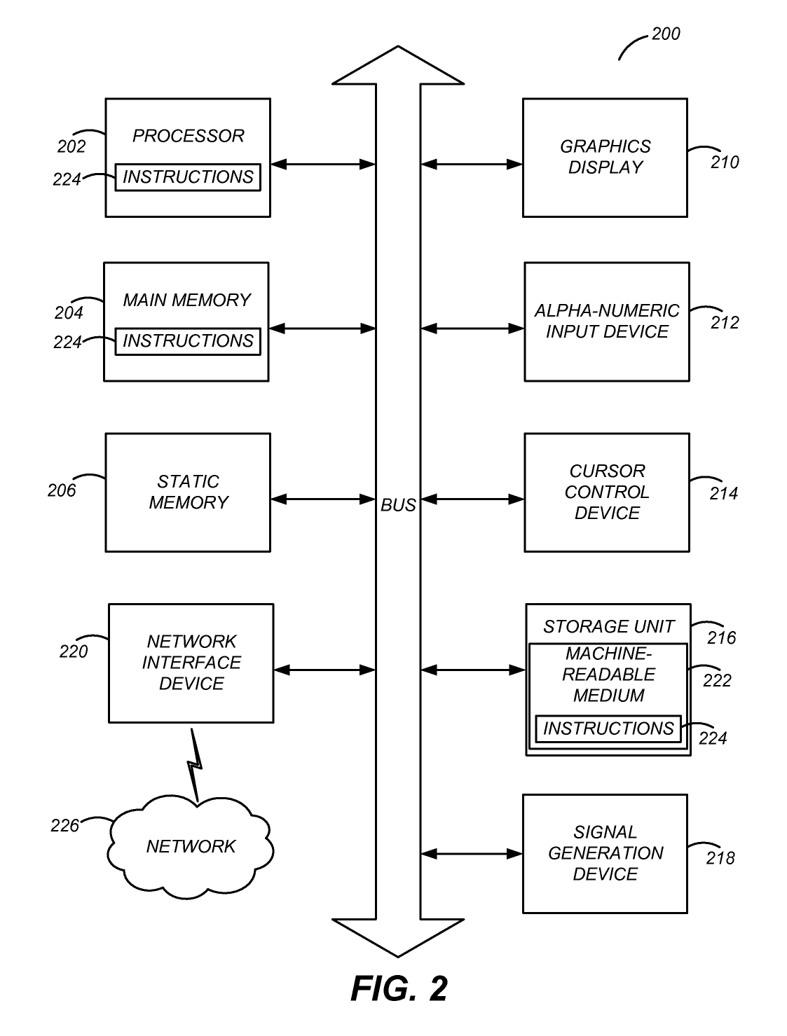

Users may access the management server 150 and content stored on the mail servers 110 by a plurality of devices 120. Two methods for accessing content are illustrated in FIG. 1: a web-based platform 130 and a mobile platform 140. Depending on its configuration, the local device 120 may access the management server 150 and mail servers 110 by either the web platform 130 or the mobile platform 140, or both. Although the web platform 130 and mobile platform 140 are illustrated in FIG. 1, other configurations are also possible. An example architecture of a device is provided below in FIG. 2.

In one embodiment, the web-based platform 130 comprises a browser 132 executing on the local device 120. A backup application 134A executes in the browser 132 environment. For example, the backup application 134A may comprise an applet, an application or multimedia framework, other web application formats, or a combination thereof. The backup application 134 may execute in a virtual machine or run-time environment external to the browser 132, while communicating with the browser 132 by a plug-in or application programming interface (API). In one embodiment, the mobile platform 140 comprises a backup application 134B, composed of markup language or native libraries 144, executing in the mobile operating system 142 environment. Other application formats are also possible. For example, the backup application 134 may comprise a desktop application executed by the operating system of the local device 120. As used herein, “backup application 134” may refer to any of the browser 132-based backup application 134A, the native mobile 144 application 134B, or a desktop application.

### Computing Machine Architecture

Turning briefly to FIG. 2, illustrated is a block diagram of an example machine able to read instructions from a machine-readable medium and execute them in a processor (or controller), as an example of the local device 120 or servers 110, 150. Specifically, FIG. 2 shows a diagrammatic representation of a machine in the example form of a computer system 200 within which instructions 224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 224 (sequential or otherwise) corresponding to program code (or software) that specify actions to be taken by that machine. Further, while only a single machine is illustrated, the term “machine” shall also be taken to include any collection of machines that individually or jointly execute instructions 224 to perform any one or more of the methodologies discussed herein.

The example computer system 200 includes one or more processors 202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 204, and a static memory 206, which are configured to communicate with each other via a bus 208. The computer system 200 may further include graphics display unit 210 (e.g., a plasma display panel (PDP), a liquid crystal display (LCD), a projector, or a cathode ray tube (CRT)). The computer system 200 may also include alphanumeric input device 212 (e.g., a keyboard), a cursor control device 214 (e.g., a mouse, a trackball, a joystick, a motion sensor, or other pointing instrument), a storage unit 216, a signal generation device 218 (e.g., a speaker), and a network interface device 220, which also are configured to communicate via the bus 208.

The storage unit 216 includes a machine-readable medium 222 on which is stored instructions 224 (e.g., software) embodying any one or more of the methodologies or functions described herein. The instructions 224 (e.g., software) may also reside, completely or at least partially, within the main memory 204 or within the processor 202 (e.g., within a processor's cache memory) during execution thereof by the computer system 200, the main memory 204 and the processor 202 also constituting machine-readable media. The instructions 224 (e.g., software) may be transmitted or received over a network 226 via the network interface device 220.

While machine-readable medium 222 is shown in an example embodiment to be a single medium, the term “machine-readable medium” should be taken to include a single medium or multiple media (e.g., a centralized or distributed database, or associated caches and servers) able to store instructions (e.g., instructions 224). The term “machine-readable medium” shall also be taken to include any medium that is capable of storing instructions (e.g., instructions 224) for execution by the machine and that cause the machine to perform any one or more of the methodologies disclosed herein. The term “machine-readable medium” includes, but not be limited to, data repositories in the form of solid-state memories, optical media, and magnetic media.

### Overview of File Backup Process

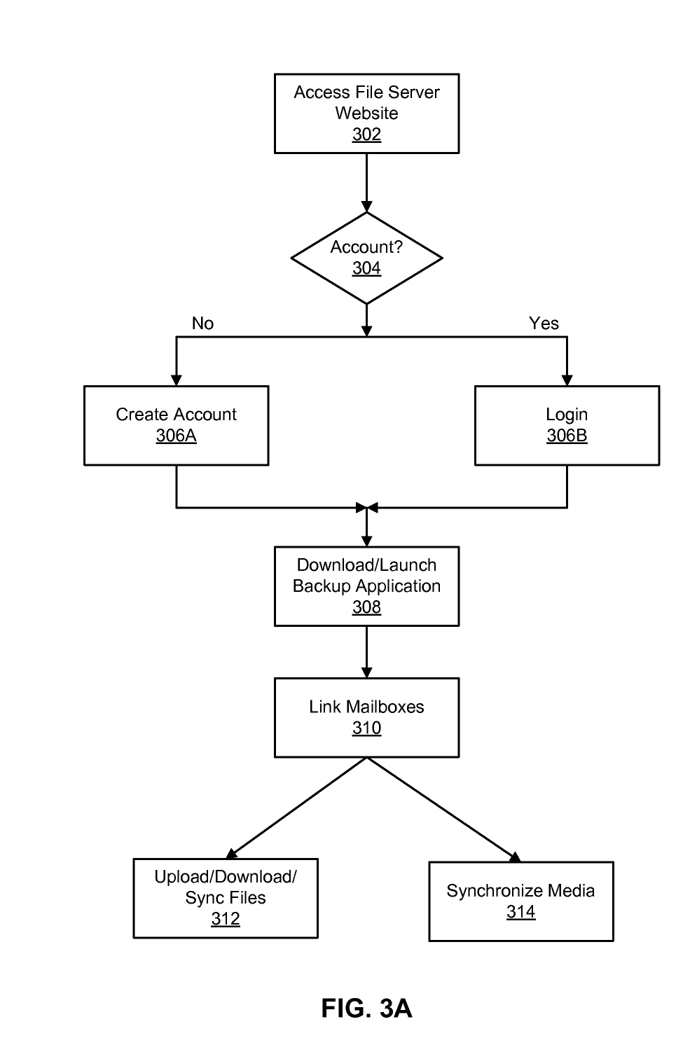

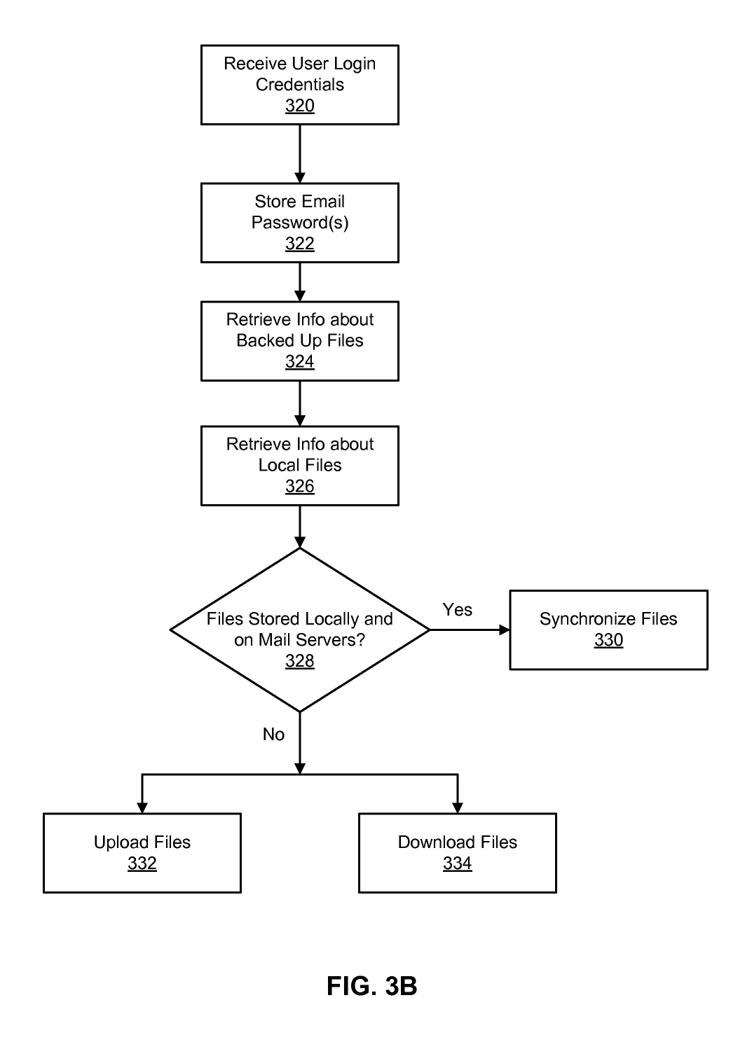

FIG. 3A is a flowchart illustrating an example of a user initiation of a file backup operation. To initiate the process, the user uses the device 120 to access 302 the website of the management server 150, for example by directing the browser 132 to the website. If the user has not established an account 304 on the management server 150, the user creates 306A an account by creating login credentials. For example, the user may specify a username and password for his backup account. The management server 150 stores the login credentials in the file information database 155. In one embodiment, the management server 150 may also store other information in association with the login credentials, such as the IP address of the local device 120 used to access the management server 150, the operating system of the local device 120, and the type of browser 132. If the user has already established an account 304, the user provides his login credentials to log in 306B to his backup account.

The backup application 134 may be downloaded 308 to the user's device 120, and optionally saved by the device 120. For example, the application 134 may be cached by the browser 132 and/or saved to a memory of the local device 120 to reduce communication bandwidth between the management server 150 and the local device 120. Alternatively, if the backup application 134 has previously been cached or saved on the local device, or if the backup application 134 is a web application, the local device 120 launches 308 the backup application 134. In one embodiment, if the backup application 134 has been modified on the management server 150 since the device 120 saved the application 134, the management server 150 may push a new version of the backup application 134 to the local device 120.

The user may link 310 one or more mailboxes to his account on the management server 150. To link 310 the one or more mailboxes, the user provides the username, domain name, and password for each of the desired email accounts to the management server 150. The management server 150 stores the email username and domain name in association with the user's backup username in the file information database 155. The password may also be saved in the file information database 155 or may be saved locally. The management server 150 may also retrieve information about each added email account, including the total storage space of the mailbox and the available storage space.

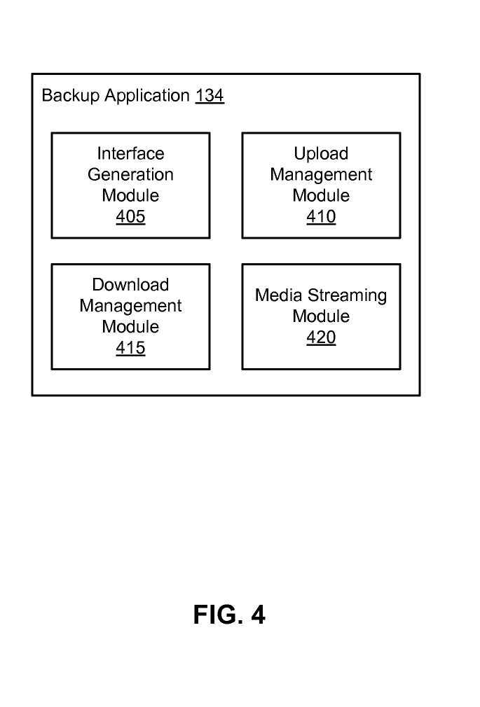

The user may then use the downloaded backup application 134 to upload, download, and/or synchronize 312 files stored on the local device 120 and/or in the mail servers 110 associated with the user's backup account. The user can also synchronize 314 media, for example music playlists or video content, between the local device 120 and the mail servers 110 for media playback. The processes for uploading, downloading, and synchronizing files are described further with respect to FIGS. 4-8.

FIG. 3B is a flowchart illustrating an overview of the file backup process, according to one embodiment. In one embodiment, the steps of the process illustrated in FIG. 3B are performed by the backup application 134. Other embodiments may perform different or additional steps, and may perform the steps in a different order.

The backup application 134 receives 320 the user's login credentials for the backup account on the management server 150 and the email accounts on the mail servers 110 associated with that user. The backup application 134 may store 332 the email password(s) locally, such as in a cookie stored by the browser 132, or may store 322 the email password(s) in the file database 155. In one embodiment, the stored email passwords are encrypted to prevent unauthorized access.

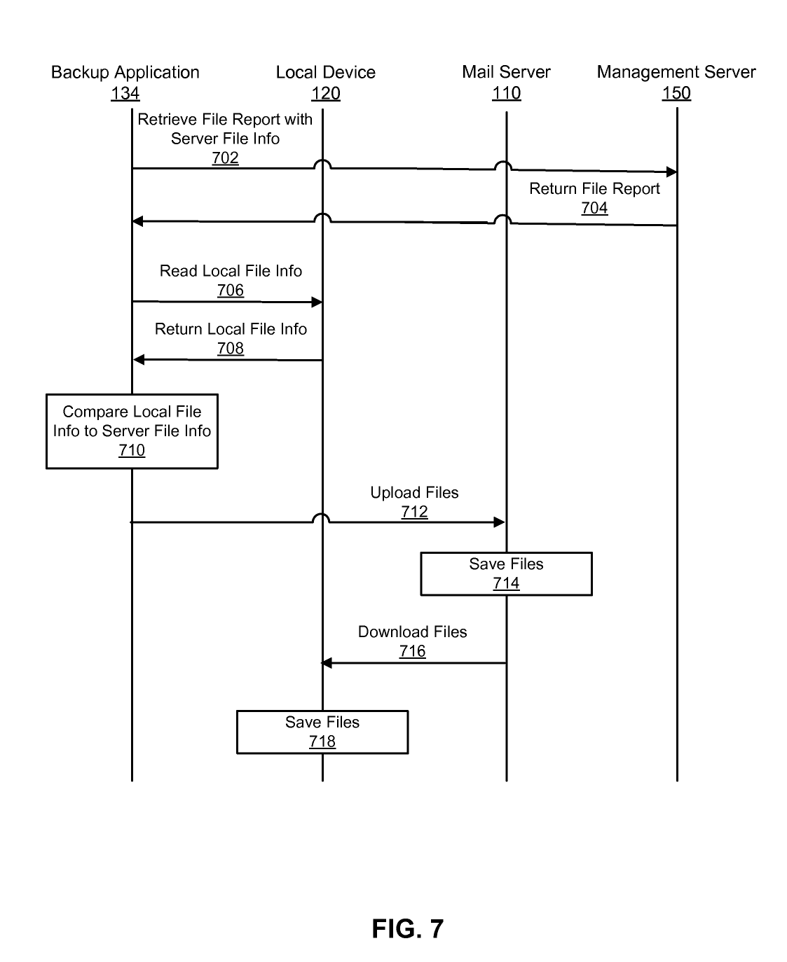

Using the user's backup account login credentials, the backup application 134 retrieves 324 information from the management server 150 about files that the user has already backed up to his email accounts, and retrieves 326 information about files stored on the local device 120. The backup application 134 may compare the information retrieved from the management server 150 to the information retrieved from the local device to determine 328 whether files are stored both locally and on a mail server 110. If a file is stored in both locations, the backup application 134 synchronizes 330 versions of the files stored in the two locations. One embodiment of a process for synchronizing 330 files is illustrated in FIG. 7.

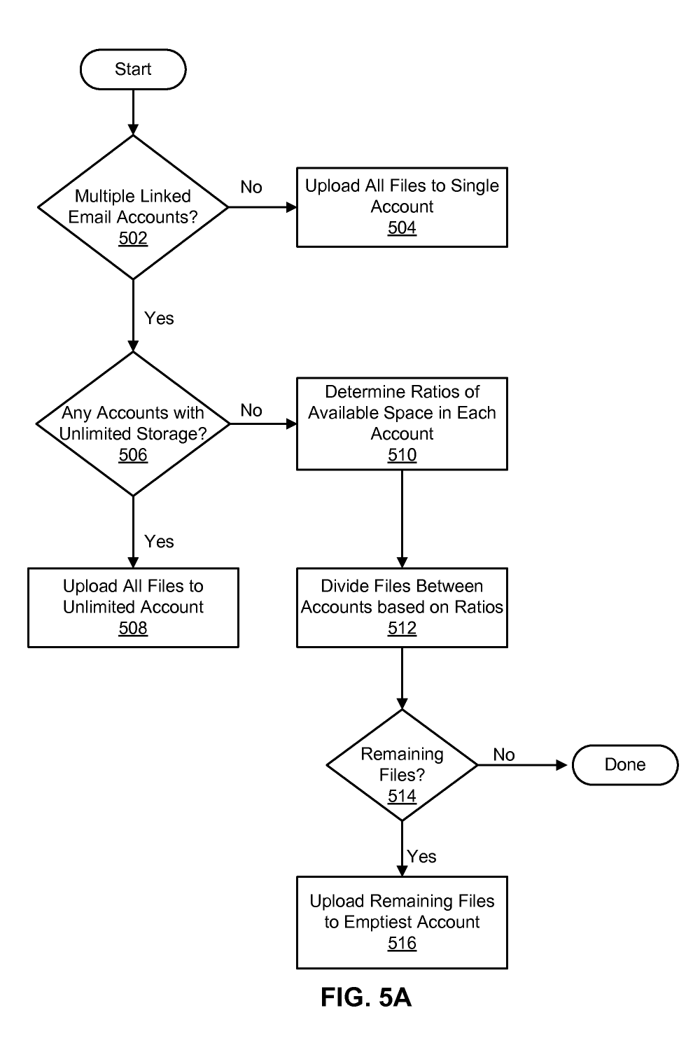

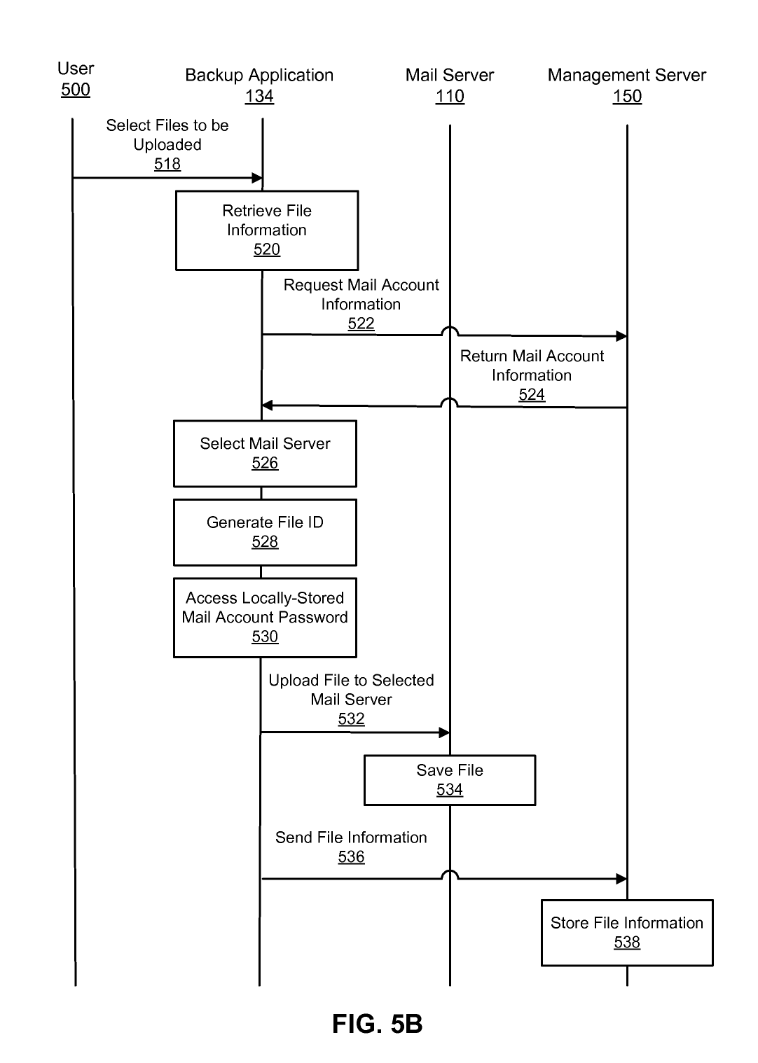

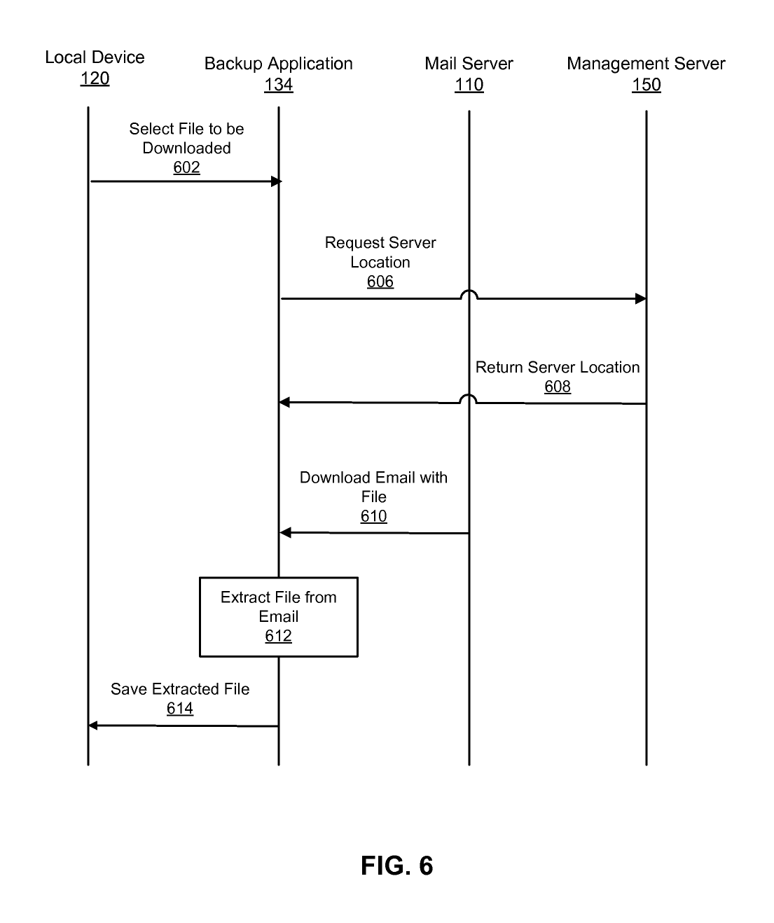

If a file is not stored 328 both locally and on a mail server 110, the backup application 134 either uploads 332 the file (if it is stored locally, but not on a mail server 110), or downloads 334 the file (if it is stored on a mail server 110, but not locally). One embodiment of a process for uploading 332 files is illustrated in FIG. 5B, and one embodiment of a process for downloading 334 files is illustrated in FIG. 6. In one embodiment, the backup application 134 synchronizes 330, uploads 332, and downloads 334 files in response to user requests, received, for example, at a user interface generated by the backup application 134.

### Backup Application

FIG. 4 is a block diagram illustrating example modules with the backup application 134. As described above, the backup application 134 may be configured as a web application, a desktop application, a native mobile application, or a hybrid configuration. In one embodiment, the backup application 134 comprises an interface generation module 405, an upload management module 410, a download management module 415, and a media (e.g., music or video) streaming module 420. Other embodiments of the backup application 134 may comprise different or additional modules, and the functionalities may be distributed differently among the modules.

The interface generation module 405 generates a user interface that is provided for display on a screen of the local device 120. The user interface is configured to allow the user to upload content, access uploaded content, play media files, manage user account information, and other functions. The user interface generated by the interface generation module 405 may display a list of the files the user has uploaded to a mail server 110, allowing the user to browse, organize, access, and share the files. If files are organized into a folder hierarchy, the user interface may display the folder hierarchy and support functionality for expanding and collapsing the displayed contents of the folders. The user interface may further support various methods for users to upload, download, and/or organize files. For example, the interface generation module 405 may support drag and drop functionality, such that users can drag files to be uploaded onto the user interface, organize uploaded content by dragging files to folders, etc. The interface generation module 405 thus supports the file backup and synchronization functions of the backup application 134 by providing a front-end for user interactions with the functions.

### Uploading Files

The upload management module 410 interfaces between the local system of the device 120, the browser 132, the management server 150, and the mail servers 110 for retrieving files to be uploaded, uploading the files, and indexing the locations of the uploaded files. The upload management module 410 may receive user selections of files to be uploaded, or may automatically back up files on the local device 120 by uploading them to the mail servers 110. In one embodiment, the files to be uploaded are media files such as music files (e.g., in a WMA or MP3 format). The upload management module 410 receives user selections of music files to be uploaded by receiving a selection of one or more music playlists. The playlist may be a list of songs, which may or may not be in a specified ordering. The upload management module 410 is configured to identify the files corresponding to each of the songs in the playlist(s) to be uploaded, retrieve the files from the local device 120, upload the music files to mail servers 110, and index the locations of the uploaded music files for later playback. Because a song may appear on multiple playlists, the upload management module 410 may determine whether the corresponding music files have previously been uploaded to a mail server 110. In one embodiment, one copy of each music file is uploaded to mail servers 110, rather than uploading a separate copy for each playlist a user requests to upload. A similar process can be applied to other media files such as video files (e.g., in MPEG4 or AVI format).

When a file stored on the local device 120 has been identified for being uploaded to a mail server 110, the upload management module 410 retrieves the file from memory of the local device 120 and extracts information about the file, including the local file path (specifying the location of the file on the local device 120, as well as its name), file separator, file size, file type (e.g., .doc, .mp3, .jpeg, .mp4, .avi, etc.), the date the file was created, and the date and time of its last modification. In one embodiment, the upload management module 410 selects an email account associated with the user's backup account, and uploads the file to the selected mail server by the IMAP protocol. The upload management module 410 is also configured to send the file information to the management server 150 for storage in the file database 155, from which the information can be referenced for later retrieval of the file.

In one embodiment, the upload management module 410 selects a mail server 110 to which new files will be uploaded based on a series of rules. FIG. 5A is a decision tree illustrating an example process for mail server 110 selection. Although the process for selecting a mail server 110 is discussed in terms of particular rules, the upload management module 410 may use other similar or additional rules to select a mail server 110, or apply the rules in a different order than is illustrated in FIG. 5A.

The upload management module 410 determines 502 whether multiple email accounts are linked to the user's backup account. If only a single account is connected, the upload management module 410 uploads 504 all files to the one connected account, and the process ends. If multiple email accounts are available, the upload management module 410 may determine 506 whether any of the connected accounts have unlimited storage space. If a mail account does have unlimited storage space, the upload management module 410 may upload 508 all new files to the unlimited account. If no connected accounts have unlimited space, the upload management module 410 may determine 510 ratios of the available space in each candidate account, and divide 512 the files between the accounts according to the ratio. For example, six files of equal size (e.g., 10 Mb) are to be uploaded to either mail server A, which has 5 GB available space, or server B, which has 10 GB of available space. The upload management module 410 process determines that the ratio of available space on server A to the available space on server B is 1:2. The upload management module 410 divides 512 the six files among the servers according to the 1:2 ratio, sending two of the 10 Mb files to server A and the remaining four files to server B. The upload management module 410 may also perform additional steps to select a mail account when multiple accounts of limited size are available. For example, the upload management module 410 may determine whether an account can be accessed (e.g., whether the user provided the correct password), or whether an account has a small percentage of available space remaining (e.g., less than 5%). If these conditions apply, the upload management module 410 may select alternative accounts by steps 502-512.

In one embodiment, if the upload management module 410 determines 514 that the files cannot be evenly divided 512 between the mail servers 110, the upload management module 410 may upload 516 any remaining files to the mail server 110 having the most available space. For example, if a seventh 10 Mb file were to be uploaded with the six files in the above example, the upload management module 410 may determine 514 that the seven files cannot be evenly divided between two servers according to the ratio 1:2. As such, six of the files may be divided 512 between server A and server B according to the 1:2 ratio, and the seventh file uploaded 516 to server B because server B has more available space than server A. Other alternatives for upload include determining the available email having greatest available storage, most recent storage activity, or greatest connection speed.

One embodiment of the process for uploading files to mail servers 110 for backup is illustrated in the interaction diagram of FIG. 5B. FIG. 5B shows interactions between a user 500, the backup application 134, a mail server 110, and the management server 150. In the diagram, time flows from top to bottom of the figure and horizontal arrows between entities represent communications. In one embodiment, the steps described as being performed by the backup application 134 are performed by the upload management module 410, although other modules of the backup application 134 may perform some or all of the steps. Furthermore, although a single mail server 110 is shown in FIG. 5B, it is to be understood that multiple mail servers 110 may be involved in the file backup process.

In the illustrated example process, the user 500 selects 518 one or more files to be uploaded from the local device 120 to a mail server 110. The user 500 may select 518 a file by interacting with the interface generated by the interface generation module 405, such as by selecting a check box adjacent to a filename, or by dragging files from a folder on the local device 120 to the user interface. The backup application 134 receives the user selections of files to be uploaded. For each new file to be uploaded, the backup application 134 retrieves 520 information about each file from the local device 120.

The backup application 134 requests 522 information about the user 500's mail accounts from the management server 150. The mail account information may include the domain name of the mail servers 110 associated with the user's file backup account, the username for each mail account, and the available storage space for each account. The management server 150 queries the file information database 155 and returns 524 the mail account information to the backup application 134. The returned mail account information may include the username, domain name, IMAP port, and available storage space of each account the user has linked to his file backup account. Based on the mail account information, the backup application 134 selects 526 a mail server 110, for example by using the decision tree illustrated in FIG. 5A.

The backup application 134 generates 528 a file identifier for the file selected by the user. The file identifier may be used by the backup application 134 and mail server 150 to index the file and information about the file. The backup application 134 may access 530 the password for the selected email account that is stored locally or in the file server 155. Alternatively, the backup application 134 may prompt the user to enter the password for the account. Using the password for the selected account, the backup application uploads 532 the file selected by the user 500 to the determined mail server 110. In one embodiment, the file is uploaded 532 directly from the local device 120 to the IMAP mail server 110, rather than being sent (e.g., via the SMTP mail server) to the IMAP server 110, to increase the speed of the upload 532. In one embodiment, the backup application 134 uploads 532 the file by generating an email and attaching the file to the email. For example, the subject of the email may contain the file path for the attached file. The body of the email may include other information about the file, such as the file identifier, the time the file was uploaded to the mail server 110, or information about the contents of the file (e.g., file format or keywords). In one embodiment, the user 500 may be able to add a note to the email, for example to describe the content of the file. The mail server 110 saves 534 the email generated by the backup application 134, including the file attached to the email.

The backup application 134 sends 536 information about the uploaded file to the management server 150, including the file path on the local device 120, the location of the file on a mail server 110 (e.g., the username and domain name of the account to which the file was uploaded, and the folder of the email account in which the file was stored), and a file identifier used to index the uploaded file on the management server 150. Other information may optionally be sent to the management server 150 and indexed by the file identifier, for example, the time stamp of the last modification to the file or information about the local device 120 from which the file was uploaded (e.g., IP address, type of web browser, operating system, or the category of the device). The management server 150 stores 538 the information received from the backup application 134. In one embodiment, the management server 150 stores 538 the received information in the file information database 155, with each file indexed by the file identifier.

### Downloading Files

Returning to FIG. 4, the download management module 415 interfaces between the mail servers 110, management server 150, and local device 120 for retrieving files stored on the mail servers 110. In one embodiment, the download management module 415 retrieves a file report (e.g., upon initialization of the backup application 134) from the management server 150, specifying files that the user has backed up in association with his backup account. If a user requests to download one or more of the files to a local device 120, the download management module 415 retrieves the file identifier of the requested file from the file report and requests information about the file from the management server 150 using the file identifier. In particular, the download management module 415 requests the email username and domain of the email account in which the file is stored. Based on the location received from the management server 150, the download management module 415 accesses the file requested by the user and downloads the file from the corresponding mail server 110 to the local device 120.

One embodiment of the process for downloading a file stored on a mail server 110 is illustrated in the interaction diagram of FIG. 6. FIG. 6 shows interactions between the user 500, the backup application 134, a mail server 110, and the management server 150. In the diagram, time flows from top to bottom of the figure and horizontal arrows between entities represent communications. In one embodiment, the steps described as being performed by the backup application 134 are performed by the download management module 415, although other modules of the backup application 134 may perform some or all of the steps.

The user uses the local device 120 to select 602 a file to be downloaded to the device 120. In one embodiment, the user selects the file by interacting with the interface generated by the user interface generation module 405. Using the file identifier of the selected file, the backup application 134 requests 606 the server location of the selected file from the management server 150, including the email account information (e.g., username and domain name) and the location of the file in the email account. The management server 150 accesses the file information database 155 to retrieve the file's server location stored in association with the file identifier determined The management server 150 returns 608 the server location to the backup application 134. The backup application 134 retrieves the email with the file from the returned server location and downloads 610 the email. The file is extracted 612 from the email, and saved 614 to the local device 120.

### Synchronizing Files

Referring now to FIG. 7, illustrated is an example process for synchronizing files between the local device 120 and mail servers 110. As described with respect to FIG. 7, “synchronization” includes a process for managing versions of a file that is stored both on a local device 120 and a mail server 110. If a file is stored on the local device 120 and has not previously been uploaded to a mail server 110, the backup application 134 uploads the file, for example, by the process illustrated in FIG. 5. If a file is stored on a mail server 110 but is not stored locally by the local device 120, the backup application 134 downloads the file, for example by the process illustrated in FIG. 6.

In one embodiment, the file synchronization process involves interactions between the backup application 134, the local device 120, mail servers 110, and the management server 150. In the diagram, time flows from top to bottom of the figure and horizontal arrows between entities represent communications. In one embodiment, the steps described as being performed by the backup application 134 are performed by one or both of the upload management module 410 and the download management module 415, although other modules of the backup application 134 may perform some or all of the illustrated steps.

The backup application 134 retrieves 702 a file report from the management server 150 identifying files synchronized from the mail servers 110 that are stored on the local device 120. In one embodiment, the file report is retrieved 702 by the backup application 134 sending an identifier of the local device 120 to the management server 150. The management server 150 determines files in the file database 155 associated with the device identifier, and returns 704 a list of the files stored on the device 120. For each file on the device 120, the returned list may include the file name, local file path, file type, size of the file on the mail server 110, and the date and time the file was modified on the mail server 110.

The backup application 134 also retrieves 708 file information from the local device 120. In one embodiment, the backup application 134 retrieves 708 information about the files included in the report received from the management server 150. The backup application 134 may alternatively retrieve 708 information about user-specified files (if the user has selected particular files to be synchronized), or may retrieve 708 information about all files stored on the local device 120 for comparison to the list received from the management server 150. The local device 120 returns information about the local versions of the files.

Based on the file information retrieved from the local device 120 and the management server 150, the backup application 134 compares 710 the local version and the mail server version of each file to be synchronized. The comparison 710 may include comparing the last modified date and time of the local version and mail server version. If, based on the comparison 710, the backup application 134 determines that a file has last been modified on the local device 120, the backup application 134 uploads 712 the file to the mail server 110. In one embodiment, the mail server 110 to which the file is uploaded 712 is the same mail server 110 previously storing the file. The mail server 110 saves 714 the uploaded file. If the backup application 134 determines based on the comparison 710 that a file has last been modified on the mail server 110, the backup application 134 downloads 716 the file from the mail server 110 to the local device 120, which saves 718 the downloaded file. In one embodiment, if the file has been modified on both the local device 120 and the mail server 110, the backup application 134 uploads 712 the file from the local device 120 to the mail server 110, though other policies may be applied to manage conflicts. It is noted that in some embodiments, rather than uploading 712 and downloading 716 entire files, the backup application 134 may upload 712 or download 716 only the modified portions of files.

The process illustrated in FIG. 7 may be performed upon startup of the backup application 134. For example, the process may be performed when the user downloads or launches the application 134, logs into his backup account through the application 134, or powers on the local device 120. Alternatively, the process of FIG. 7 may be performed on-demand, for example when the user clicks a “Synchronize Now” button on the interface generated by interface generation module 405. Users may select individual files for synchronization, or the backup application 134 may synchronize all the files stored on the device 120 currently used by the user and backed up to the mail servers 110.

### Playing Media

As discussed above, media files (e.g., music files or “songs”) are one type of file that may be backed up by mail servers 110 and managed by interactions between the backup application 134 and the management server 150. Music files may be configured to be read and played by a media player executing, for example, on the local device 120 or in the browser 132. Furthermore, music files may be accessed individually (e.g., a user selects a single song to be played), or users may organize music files into playlists, in which each playlist is a list of a plurality of songs that may or may not have a specified ordering. Playlists may be defined on the local device 120 (e.g., the user may upload entire playlists for storage on the mail servers 110), or the user may interact with the interface generated by backup application 134 to define playlists of the uploaded music files. The music files may be configured to be read and played by a media player executing, for example, on the local device 120 or in the browser 132. It is noted that the principles described can also apply to other media files, e.g., video files.

Returning to FIG. 4, the media streaming module 420 of the backup application 134 interfaces between the mail servers 110 and a media player executing on the local device 120. In one embodiment, the media streaming module 420 is configured to manage playlists, download music files from mail servers 110 upon requests to play the files, and send the downloaded files to the media player for playing. As a result, the media streaming module 420 effectively makes a user's email account(s) into a media gallery and enables the user to play songs from his music library on any device. It is noted that a user's library of music files may be distributed across a plurality of mail servers 110, but the media streaming module 420 can play music as if it were stored at a single location based on the file information maintained by the management server 150.

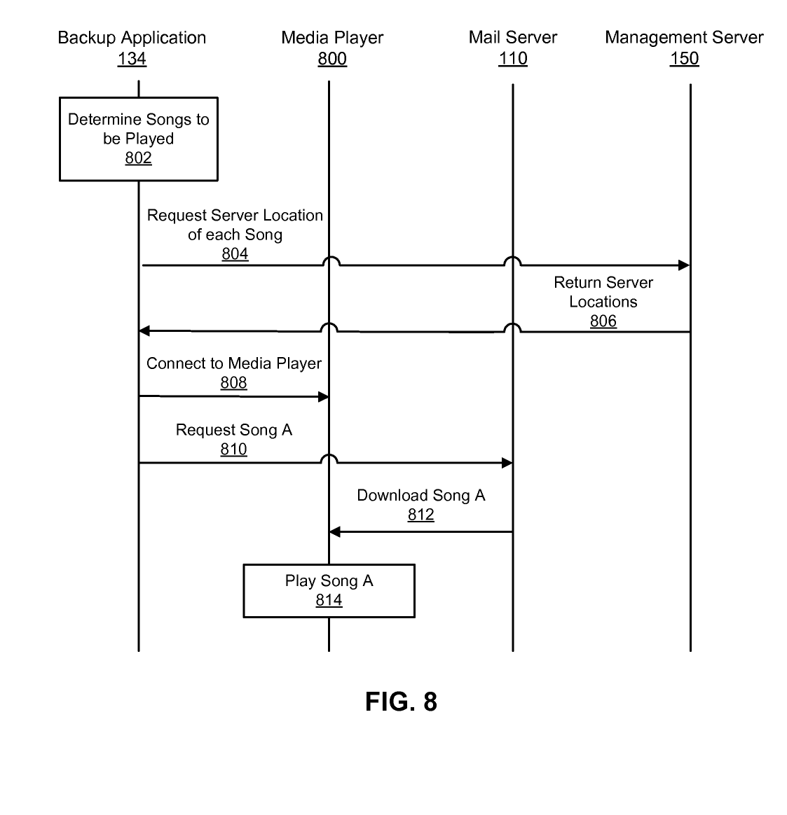

One embodiment of the process for playing a playlist stored on a mail server 110 is illustrated in the interaction diagram of FIG. 8. FIG. 8 shows interactions between the backup application 134, a media player 800, a mail server 110, and the management server 150. In the diagram, time flows from top to bottom of the figure and horizontal arrows between entities represent communications. In one embodiment, the steps described as being performed by the backup application 134 are performed by the media streaming module 420, although other modules of the backup application 134 may perform some or all of the steps.

The backup application 134 determines 802 one or more songs to be played. For example, the user may select a song in the interface generated by the interface generation module 405 and click a “play” button. The user may also select a playlist comprising a plurality of songs. The storage application 804 determines the file identifier associated with each song to be played and requests 804 the location of each song on the mail servers 110. The management server 150 accesses the file information database 154 and returns 806 the server locations of the songs.

The backup application 134 connects 808 to the media player 800. In one embodiment, the media player 800 is a standalone player executing on the user's local device 120, such as iTUNES® or WINDOWS MEDIA PLAYER®. Alternatively, the media player 800 may be executable by the browser 132, such as a plug-in compatible with the browser 132. In yet another embodiment, the backup application 134 may include built-in audio playback capabilities.

The backup application 134 requests 810 the first song to be played from the mail server 110, based on the server location of the song received from the management server 150. The first song is downloaded 812 from the mail server 110 and added to a queue for the media player 800, which plays 814 the first song. Steps 810-814 may be repeated for each song in a playlist, or each song a user requests to play.

### Additional Configuration Considerations

By uploading files to email servers corresponding to user's existing email accounts, the disclosed embodiments beneficially allow for storage of files accessible from a plurality of devices. The management server maintains a database with information about all files a user has uploaded, enabling client-side backup applications to retrieve content on demand. Moreover, the database maintained by the management server effectively groups multiple email servers into a single logical storage entity, increasing the available storage space over that provided by a single email account. As one particular example, the backup applications provide users with the ability to play content from their music libraries from any device, even if music files of the libraries are stored across a plurality of email servers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules, for example, as described with respect to FIG. 4, may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors, such as processor 202) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 202, that are temporarily configured (e.g., by software embodied through instructions 124) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory such as 204 or 206). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for email file through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for synchronizing files, the method comprising:
accessing a file stored in a memory of a local device, the accessing comprising determining a local file path specifying a location of the file in the memory;
uploading the file to an email server, the email server configured to store the uploaded file in a location specified by email account information comprising an email username and domain name;
sending the local file path, the email account information, and an identifier of the uploaded file for storage by a management server; and
providing access to the uploaded file by the email account information and the file identifier.

2. The method of claim 1, wherein uploading the file comprises:
attaching the file to an email; and
sending the file to an email server using the IMAP protocol.

3. The method of claim 1, wherein uploading the file comprises accessing an email password stored on the local device.

4. The method of claim 1, further comprising:
selecting an email account from a plurality of email accounts of a user, each email account having an available storage space and associated with an email server, wherein the selection is based on the available storage space of each of the email accounts, and wherein uploading the file comprises uploading the file to the email server associated with the selected email account.

5. The method of claim 1, further comprising:
comparing a last modification time of the file on the local device to a last modification time of the uploaded file; and
synchronizing the file on the local device with the uploaded file based on the comparison.

6. The method of claim 1, wherein the uploaded file is a music file, and wherein the method further comprises:
receiving from a client device, a request to play the music file;
retrieving from the management server the file identifier of the music file and the email account information specifying the location of the music file on the email server; and
downloading the music file from the email server to the client device for execution by a media player, the downloading based on the retrieved email account information and the file identifier.

7. The method of claim 6, further comprising:
uploading a plurality of music files to one or more email servers; and
accessing a playlist comprising a listing of the plurality of music files;
wherein receiving the request to play the music file comprises receiving a request to play each music file listed by the playlist.

8. A non-transitory computer-readable medium configured to store instructions, the instructions when executed by a processor cause the processor to:
access a file stored in a memory of a local device, the accessing comprising determining a local file path specifying a location of the file in the memory;
upload the file to an email server, the email server configured to store the uploaded file in a location specified by email account information comprising an email username and domain name;
send the local file path, the email account information, and an identifier of the uploaded file for storage by a management server; and
access the uploaded file by the email account information and the file identifier.

9. The non-transitory computer-readable medium of claim 8, wherein the instructions causing the processor to upload the file further cause the processor to:
attach the file to an email; and
send the file to an email server using the IMAP protocol.

10. The non-transitory computer-readable medium of claim 8, wherein the instructions causing the processor to upload the file further cause the processor to access an email password stored on the local device.

11. The non-transitory computer-readable medium of claim 8, further comprising instructions that cause the processor to:
select an email account from a plurality of email accounts of a user, each email account having an available storage space and associated with an email server, wherein the selection is based on the available storage space of each of the email accounts, and wherein the instructions that cause the processor to upload the file comprise instructions that cause the processor to upload the file to the email server associated with the selected email account.

12. The non-transitory computer-readable medium of claim 8, further comprising instructions that cause the processor to:
compare a last modification time of the file on the local device to a last modification time of the uploaded file; and
synchronize the file on the local device with the uploaded file based on the comparison.

13. The non-transitory computer-readable medium of claim 8, wherein the uploaded file is a music file and further comprising instructions that cause the processor to:
receive from a client device, a request to play the music file;
retrieve from the management server the file identifier of the music file and the email account information specifying the location of the music file on the email server; and
download the music file from the email server to the client device for execution by a media player, the downloading based on the retrieved email account information and the file identifier.

14. The non-transitory computer-readable medium of claim 8, further comprising instructions that cause the processor to:
upload a plurality of music files to one or more email servers; and
access a playlist comprising a listing of the plurality of music files;
wherein the instructions that cause the processor to receive the request to play the music file comprise instructions that cause the processor to receive a request to play each music file listed by the playlist.

15. A computer system for synchronizing files from an email server, the system comprising:
a processor for executing computer program instructions; and
a non-transitory computer-readable storage medium comprising executable computer program instructions for:
accessing a file stored in a memory of a local device, the accessing comprising determining a local file path specifying a location of the file in the memory;
uploading the file to an email server, the email server configured to store the uploaded file in a location specified by email account information comprising an email username and domain name;
sending the local file path, the email account information, and an identifier of the uploaded file for storage by a management server; and
accessing the uploaded file by the email account information and the file identifier.

16. The computer system of claim 15, wherein uploading the file comprises:
attaching the file to an email; and
sending the file to an email server using the IMAP protocol.

17. The computer system of claim 15, wherein uploading the file comprises accessing an email password stored on the local device.

18. The computer system of claim 15, further comprising executable computer program instructions for:
selecting an email account from a plurality of email accounts of a user, each email account having an available storage space and associated with an email server, wherein the selection is based on the available storage space of each of the email accounts, and wherein uploading the file comprises uploading the file to the email server associated with the selected email account.

19. The computer system of claim 15, further comprising executable computer program instructions for:
comparing a last modification time of the file on the local device to a last modification time of the uploaded file; and
synchronizing the file on the local device with the uploaded file based on the comparison.

20. The computer system of claim 15, wherein the uploaded file is a music file and further comprising executable computer program instructions for:
receiving from a client device, a request to play the music file;
retrieving from the management server the file identifier of the music file and the email account information specifying the location of the music file on the email server; and
downloading the music file from the email server to the client device for execution by a media player, the downloading based on the retrieved email account information and the file identifier.
